(19) United States
(12) Patent Application Publication
(10) Pub. No.: US 2020/0309197 A1
(43) Pub. Date: Oct. 1, 2020

(54) TORQUE LIMITER, GEARED MOTOR, DRIVE MECHANISM AND ROBOT

(71) Applicant: NIDEC CORPORATION, Kyoto (JP)

(72) Inventors: Takahisa KITANAKA, Kyoto (JP); Keisuke FUJISAWA, Kyoto (JP)

(21) Appl. No.: 16/784,250

(22) Filed: Feb. 7, 2020

(30) Foreign Application Priority Data
Mar. 27, 2019 (JP) 2019-059844

(51) Int. Cl. F16D 7/02; B25J 9/10

(52) U.S. Cl. CPC F16D 7/024; B25J 9/102

(57) ABSTRACT

A torque limiter includes: a shaft; a first gear that includes a first teeth part with teeth on its surface on one side in a direction along the central axis; a second gear that includes a second teeth part with teeth on its surface on another side in the direction along the central axis, the second teeth part being configured to mesh with the first teeth part; and an elastic member configured to press one of the first and second gears against the other, and the first and the second teeth parts respectively have sine-waved portions where teeth surfaces of the first and the second teeth parts have a shape of a sine wave when viewed in a direction orthogonal to the central axis, the teeth surfaces of the first and the second teeth parts being configured to contact each other.

### CROSS-REFERENCE TO RELATED APPLICATIONS

The present invention claims priority under 35 U.S.C. § 119 to Japanese Application No. 2019-059844 filed on Mar. 27, 2019, the entire content of which is incorporated herein by reference.

### FIELD OF THE INVENTION

The present disclosure relates to a torque limiter, a geared motor, a drive mechanism, and a robot.

### BACKGROUND

A conventionally known torque limiter includes an input disk, an output disk, and a pressing member configured to press the input disk against the output disk, and is configured such that a rotational load applied to an output shaft causes the input disk to be pulled away from the output disk against the pressing force of the pressing member.

In such a conventional torque limiter, the teeth of the input disk come in point-contact with the teeth of the output disk when moving over the teeth of the output disk. Thus, the teeth receive excessively high pressure and wear out easily. Such worn-out teeth cause fluctuations in the operating torque of the torque limiter.

### SUMMARY

An exemplary first disclosure of the present application is a torque limiter including: a shaft extending along a central axis; a first gear that has a disk shape centered on the central axis, includes a first teeth part with a plurality of teeth on one surface thereof on one side of the torque limiter in a direction along the central axis, and is rotatable about the central axis together with the shaft; a second gear that has a disk shape centered on the central axis, and includes a second teeth part with a plurality of teeth on one surface thereof on another side of the torque limiter in the direction along the central axis, the second teeth part being configured to mesh with the first teeth part; and an elastic member configured to press one of the first gear and the second gear against another one of the first gear and the second gear, and the first teeth part and the second teeth part respectively have sine-waved portions in which teeth surfaces of the first teeth part and the second teeth part have a shape of a sine wave when viewed in a direction orthogonal to the central axis, the teeth surfaces of the first teeth part and the second teeth part being configured to contact each other.

An exemplary second disclosure of the present application is a geared motor including: the torque limiter according to the exemplary first disclosure of the present application, and a motor configured to transmit torque to the torque limiter.

An exemplary third disclosure of the present application is a drive mechanism that is driven by the geared motor according to the exemplary second disclosure of the present application.

An exemplary fourth disclosure of the present application is a robot including: the geared motor according to the exemplary second disclosure of the present application, and an arm that is driven by the geared motor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram showing an embodiment of a geared motor according to the present disclosure;

FIG. 2 is an exploded perspective view showing a torque limiter included in the geared motor shown in FIG. 1;

FIG. 3 is a side view showing a state in which a first teeth part of a first gear and a second teeth part of a second gear included in the torque limiter shown in FIG. 2 are meshed with each other;

FIG. 4 is a cross-sectional view showing a relationship between a shaft and the first gear included in the torque limiter shown in FIG. 2;

FIG. 5 is a perspective view showing the second gear included in the torque limiter shown in FIG. 2;

FIG. 6 is a view as seen in the direction of the arrow A shown in FIG. 5;

FIG. 7 is a sectional view of the second gear taken along line B-B in FIG. 5;

FIG. 8 is a view showing an example of a drive mechanism according to the present disclosure; and

FIG. 9 is a view showing an example of a robot according to the present disclosure.

### DETAILED DESCRIPTION

Hereinafter, a torque limiter, a geared motor, a drive mechanism, and a robot of the present disclosure will be described in detail on the basis of preferred embodiments shown in the accompanying drawings.

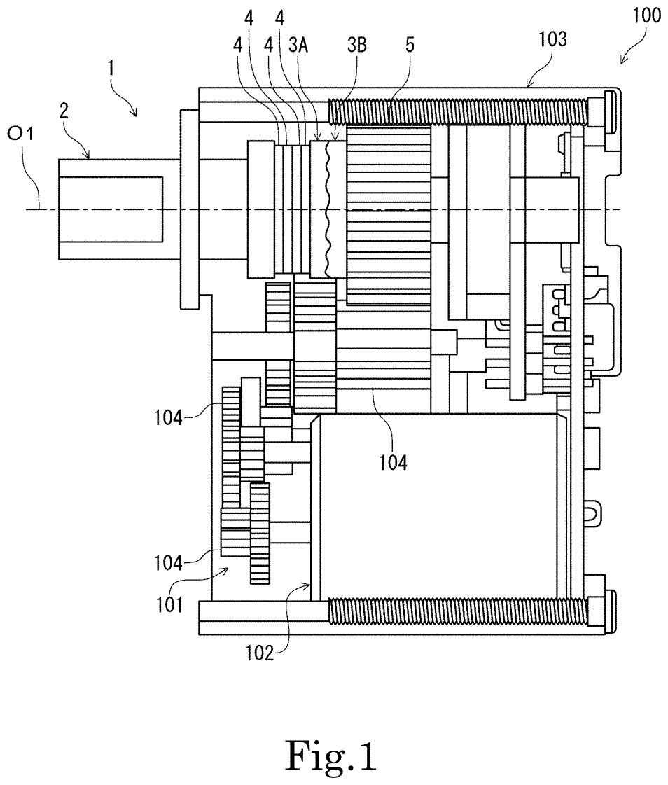

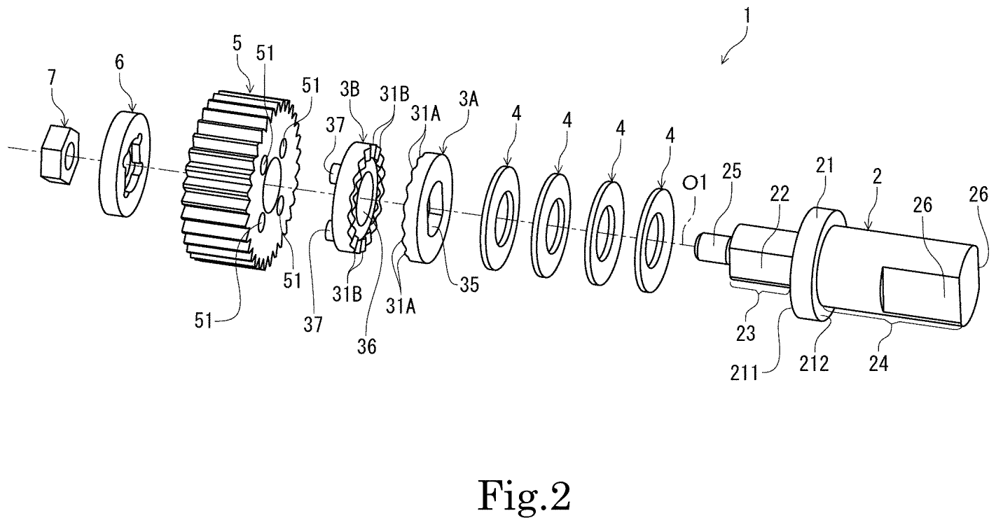

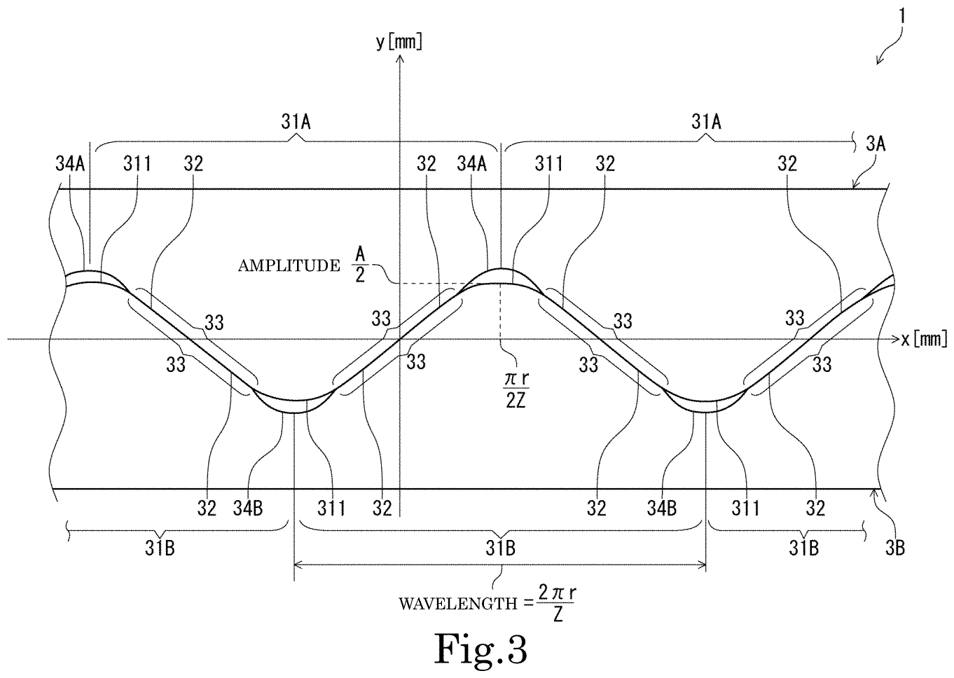

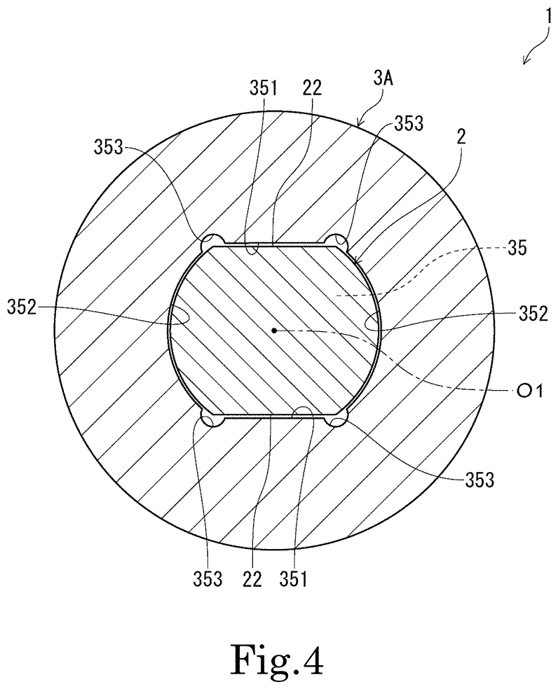

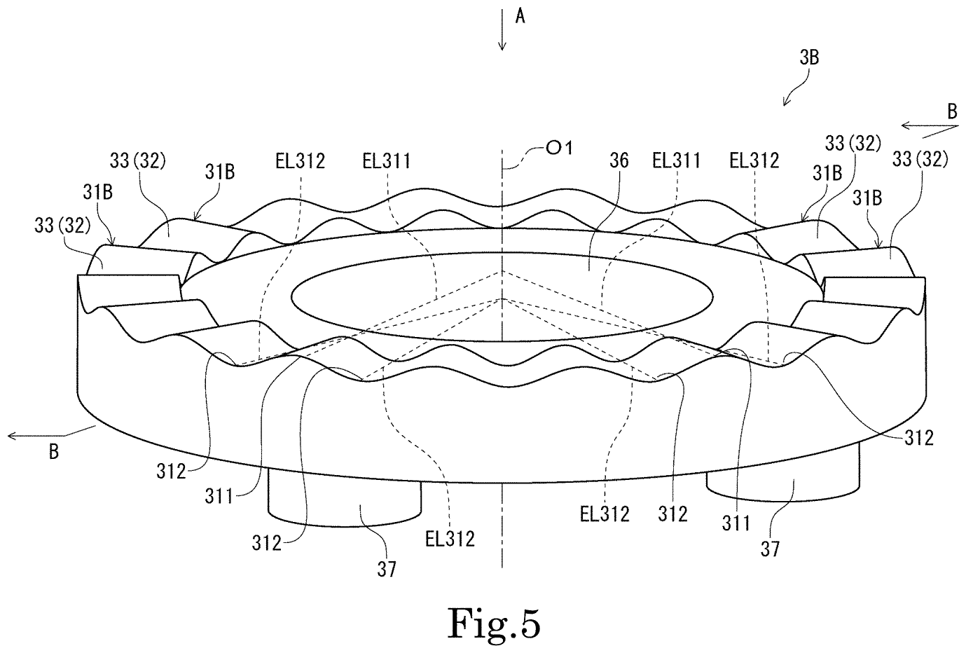

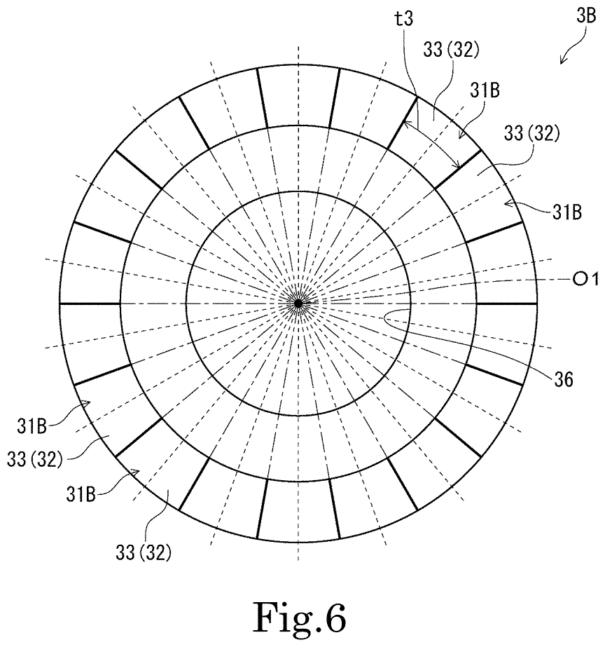

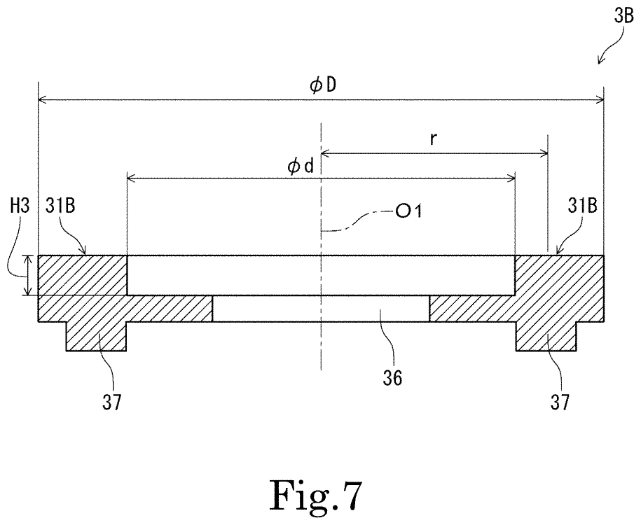

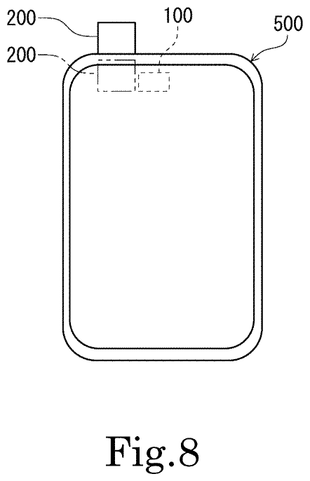

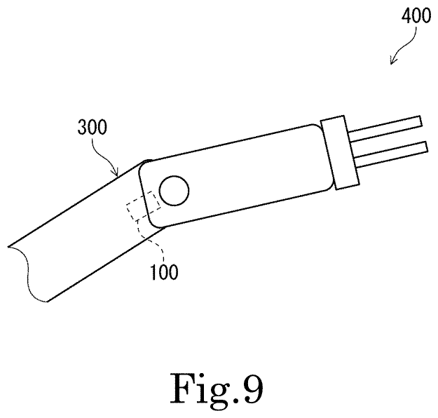

FIG. 1 is a diagram showing an embodiment of a geared motor according to the present disclosure. FIG. 2 is an exploded perspective view showing a torque limiter included in the geared motor shown in FIG. 1. FIG. 3 is a side view showing a state in which a first teeth part of a first gear and a second teeth part of a second gear included in the torque limiter shown in FIG. 2 are meshed with each other. FIG. 4 is a cross-sectional view showing a relationship between a shaft and the first gear included in the torque limiter shown in FIG. 2. FIG. 5 is a perspective view showing the second gear included in the torque limiter shown in FIG. 2. FIG. 6 is a view as seen in the direction of the arrow A shown in FIG. 5. FIG. 7 is a sectional view of the second gear taken along line B-B in FIG. 5. FIG. 8 is a view showing an example of a drive mechanism according to the present disclosure. FIG. 9 is a view showing an example of a robot according to the present disclosure. In the following description, one side of a torque limiter 1 in a direction along a central axis O1 may be simply referred to as “one side”, and the opposite side thereof, i.e., the other side of the torque limiter 1 may be simply referred to as “the other side”, for convenience of explanation. In addition, a direction orthogonal to the central axis O1 may be referred to as a “radial direction”. Further, FIG. 3 is illustrated with the coordinate axes superimposed.

A geared motor 100 shown in FIG. 1 includes the torque limiter 1, a speed reducer 101, a motor 102, and a housing 103, and is used as, for example, an on-vehicle drive source. Examples of such an on-vehicle drive source include an in-wheel motor, a drive source for a car navigation screen, a drive source for a windshield wiper, and a drive source for a door mirror.

The motor 102 is, for example, a direct current (DC) motor, and capable of transmitting torque (power) to the torque limiter 1 via the speed reducer 101. Then, the torque received by the torque limiter 1 is used to open and close an opening/closing member.

The speed reducer 101 includes a plurality of spur gears 104 that mesh with one another. This enables the torque from the motor 102 to be transmitted quickly and smoothly to the torque limiter 1.

The housing 103 houses the speed reducer 101 and the motor 102, and maintains the positional relationship between them. The housing 103 also houses part of the torque limiter 1, i.e., a first gear 3A, a second gear 3B, elastic members 4, a transmission gear 5, and the like according to this embodiment.

The torque limiter 1 is a mechanism to prevent a load on the motor 102, the spur gears 104 of the speed reducer 101, and the like by causing freewheeling in occurrence of excessive torque, i.e., in an overloaded condition. As a result, the motor 102 and other components can be protected. The torque limiter 1 includes a shaft 2, the first gear 3A, the second gear 3B, the elastic members 4, the transmission gear 5, a washer 6, and a nut 7. Hereinafter, the configuration of each member will be described.

As shown in FIG. 2, the shaft 2 is a columnar member extending along the central axis O1.

The shaft 2 has a ring-shaped flange part 21 protruding in the circumferential direction of its outer periphery at its midpoint along the central axis O1. The flange part 21 has a first opposing surface (opposing surface) 211 facing one side in the direction along the central axis O1, and a second opposing surface 212 facing the other side.

The shaft 2 includes on either side of the flange part 21 a smaller-diameter part 23 disposed on one side and a larger-diameter part 24 disposed on the other side and having an outer diameter larger than that of the smaller-diameter part 23.

In the smaller-diameter part 23, the washer 6, the transmission gear 5, the second gear 3B, the first gear 3A, and the four elastic members 4 are arranged in this order from one side to the other side. The smaller-diameter part 23 penetrates all of these members.

The smaller-diameter part 23 includes on its end surface a male thread 25 protruding toward one side. The male thread 25 is configured to be screwed into the nut 7. The nut 7 comes in contact with the washer 6. This prevents the transmission gear 5, the second gear 3B, the first gear 3A, and the elastic members 4 from being detached from the smaller-diameter part 23.

The shaft 2 has at least one pair of flat surfaces facing in opposite directions on the outer periphery thereof. The smaller-diameter part 23 has a pair of flat surfaces 22 facing in opposite directions on the outer periphery thereof. The number of the pair of flat surfaces 22 is one pair in the present embodiment, but is not limited thereto. A plurality of pairs of flat surfaces 22 may be provided, for example.

In addition, the larger-diameter part 24 also has a pair of flat surfaces 26 facing in opposite directions on the outer periphery thereof. One flat surface 26 of the pair of flat surfaces 26 and one flat surface 22 of the pair of flat surfaces 22 face in the same direction, and the other flat surface 26 and the other flat surface 22 also face in the same direction. The number of the pair of flat surfaces 26 is one pair in the present embodiment, but is not limited thereto. A plurality of pairs of flat surfaces 26 may be provided, for example.

As shown in FIG. 1, the transmission gear 5 is a spur gear that meshes with one of the spur gears 104 included in the speed reducer 101. The transmission gear 5 transmits power from the motor 102 (drive source) to the second gear 3B. The power from the motor 102 (drive source) is transmitted to the speed reducer 101, and is further transmitted in sequence to the transmission gear 5, the second gear 3B, the first gear 3A, and the shaft 2. As a result, the shaft 2 rotates around the central axis O1 to produce torque. As described above, the torque is used to open and close the opening/closing member.

As shown in FIG. 2, ring-shaped elastic members 4 are disposed opposite the transmission gear 5 through the first gear 3A and the second gear 3B. In the present embodiment, the four elastic members 4 are arranged, but the number of the elastic members 4 is not limited thereto. One, two, three, five or more elastic members 4 may be provided, for example.

The elastic members 4 press one of the first gear 3A and the second gear 3B against the other one of the first gear 3A and the second gear 3B. In the present embodiment, the elastic members 4 are arrayed along the central axis O1 in an overlapped and compressed state between the first opposing surface 211 of the shaft 2 and the first gear 3A. With this configuration, the first gear 3A can be pressed against the second gear 3B. In the pressing state, the first gear 3A and the second gear 3B reliably mesh with each other, thereby enabling transmission of the torque (power).

As will be described later, the rotation of the first gear 3A around the central axis O1 is restricted with respect to the shaft 2. This prevents the first gear 3A from rubbing against one of the elastic members 4 adjacent to the first gear 3A during rotation of the torque limiter 1 (shaft 2), which prevents wear of these members. In the same manner, the adjacent elastic members 4 are prevented from being rubbed against each other, thereby preventing wear of the elastic members 4.

The elastic members 4 are formed of disc springs. In the case where the elastic members 4 are formed of, for example, coil springs, wear of the elastic members 4 does not cause a large reduction in the elastic force. However, in the case where the elastic members 4 are formed of disc springs, wear of the elastic members 4 may cause a reduction in the elastic force. Thus, rubbing of the elastic members 4 is prevented as described above to prevent wear of the elastic members 4.

A material of the elastic members 4 may be a metal material or a resin material as long as the material has elasticity. It is preferable to use a metal material, for example, depending on the use environment of the geared motor 100.

In the present embodiment, the torque limiter 1 employs a configuration in which the transmission gear 5, the second gear 3B, and the first gear 3A are arranged in this order from one side, but the configuration thereof is not limited thereto. The torque limiter 1 may employ a configuration in which the first gear 3A, the second gear 3B, and the transmission gear 5 are arranged in this order from one side, for example. In such a case, the elastic members 4 press the second gear 3B against the first gear 3A through the transmission gear 5.

The first gear 3A is a crown gear having a disk shape centered on the central axis O1, and having a first teeth part 31A with a plurality of teeth on a surface thereof on one side in the direction along the central axis O1. The first gear 3A is rotatable around the central axis O1 together with the shaft 2. The first gear 3A functions as a clutch plate that can be placed in a closed state in which the first gear 3A is disposed close to the second gear 3B due to the elastic force of the elastic members 4, and in a separated state in which the first gear 3A is disposed further away from the second gear 3B than in the closed state against pressing by the elastic force of the elastic members 4. In the closed state, the first gear 3A and the second gear 3B mesh with each other (see FIG. 3), so that torque is transmitted from the second gear 3B to the first teeth part 31A. In the separated state, the second gear 3B rotates freely with respect to the first teeth part 31A to prevent a load on the motor 102 and the like in the overloaded condition described above.

As shown in FIG. 4, the first gear 3A has a through hole 35 through which the smaller-diameter part 23 of the shaft 2 penetrates. The inner periphery of the through hole 35 includes contact surfaces 351 that respectively contact the flat surfaces 22 of the shaft 2. This configuration appropriately restricts rotation of the first gear 3A around the central axis O1 with respect to the shaft 2.

The inner periphery of the through hole 35 further includes arc-shaped connecting surfaces 352 each of which connects the contact surfaces 351, and concave surfaces 353 each of which is disposed at a boundary between one of the contact surfaces 351 and one of the connecting surfaces 352 and is recessed in an arc shape in a direction away from the central axis O1. This configuration prevents the shaft 2 from interfering with the first gear 3A in inserting the shaft 2 into the through hole 35, regardless of, for example, the degree of processing accuracy of the through hole 35, thereby ensuring easy and smooth insertion of the shaft 2 into the through hole 35.

The connecting surfaces 352 are not limited to the arc shape when viewed in the direction of the central axis O1, and may have, for example, a shape with a linear portion. Further, the concave surfaces 353 are not limited to the arc shape when viewed in the direction of the central axis O1, and may have, for example, a shape with a linear portion.

As shown in FIG. 2, the second gear 3B is disposed on the opposite side of the first gear 3A from the elastic members 4. Such an arrangement is effective when, for example, the first gear 3A and the transmission gear 5 are to be arranged on either side of the second gear 3B. This configuration prevents the second gear 3B and the elastic members 4 from being rubbed against each other during operation of the torque limiter 1, thereby preventing wear of the second gear 3B and the elastic members 4.

The second gear 3B is a crown gear having a disk shape centered on the central axis O1, and having a second teeth part 31B with a plurality of teeth on a surface thereof on the other side in the direction along the central axis O1. As shown in FIG. 3, the second teeth part 31B of the second gear 3B meshes with the first teeth part 31A of the first gear 3A. That is, the teeth of the second teeth part 31B mesh with the teeth of the first teeth part 31A.

The second gear 3B has a through hole 36 through which the smaller-diameter part 23 of the shaft 2 penetrates. The through hole 36 has a circular shape, and receives the smaller-diameter part 23 with a “clearance fit”. With this configuration, the second gear 3B is supported by the shaft 2 in a rotatable manner around the central axis O1.

The second gear 3B includes on its surface on one side in the direction along the central axis O1 a plurality of (four in the present embodiment) protrusions 37 protruding toward the one side. The protrusions 37 are arranged at equiangular intervals around the central axis O1. The number of the protrusions 37 is not limited to four, and may be one, two, three, or five or more.

Further, the transmission gear 5 includes depressions 51 to receive the protrusions 37. This configuration connects the second gear 3B with the transmission gear 5, and thus allows the second gear 3B to rotate according to the rotation of the transmission gear 5.

In the present embodiment, the second gear 3B and the transmission gear 5 are separate components (independent members) that are joined together, but the configuration is not limited thereto. For example, the second gear 3B and the transmission gear 5 may be integrally formed of a single member. In other words, the second gear 3B may have a function as the transmission gear 5.

The materials of the first gear 3A and the second gear 3B are not limited, and it is preferable to use various metal materials, such as alloy steel for machine structures, rolled steel for general structures, and stainless steel.

As shown in FIG. 3, the first teeth part 31A and the second teeth part 31B respectively include teeth surfaces 32 that are in contact with each other. Each of the teeth surfaces 32 has a sine-waved portion 33 having a shape of a sine wave when viewed in a direction orthogonal to the central axis O1, that is, in a side view.

When the torque from the motor 102 is transmitted to the shaft 2, the torque limiter 1 is in a state where the first teeth part 31A of the first gear 3A meshes with the second teeth part 31B of the second gear 3B with the elastic force of the elastic members 4, i.e., the closed state described above.

In the overloaded condition described above, the torque limiter 1 is shifted from the closed state to the separated state in which the second gear 3B rotates with the force exceeding the force with which the first teeth part 31A of the first gear 3A meshes with the second teeth part 31 of the second gear 3B, and each tooth of the second teeth part 31 of the second gear 3B goes over the teeth of the first teeth part 31A of the first gear 3A. As a result, the second gear 3B rotates freely with respect to the first gear 3A.

In the torque limiter 1, the teeth surfaces 32 of both of the first and the second teeth parts have the sine-waved portions 33, and thus each tooth of the second teeth part 31 comes in line contact with the first teeth part 31A in the radial direction when going over the teeth of the first teeth part 31A while. With this configuration, the contact area is increased as compared with, for example, the case of point contact with the first teeth part 31A, thereby dispersing the force (pressure) applied to the teeth surface 32 of the first teeth part 31A and the teeth surface 32 of the second teeth part 31. This prevents wear on the teeth surface 32 of the first teeth part 31A and the teeth surface 32 of the second teeth part 31 (hereinafter referred to as a “wear-prevention effect”). Wear on each of the teeth surface 32 may cause fluctuations in the operating torque of the torque limiter 1, but the cause is eliminated by the wear-prevention effect, thus preventing or reducing fluctuations in the operating torque. Accordingly, torque is transmitted stably.

In addition, the wear-prevention effect eliminates the need of, for example, applying an anti-friction treatment or the like to the teeth surfaces 32, which leads to reduction in the manufacturing cost.

Further, the sine-waved portions 33 prevent each tooth of the second teeth part 31 from stopping midway through going over the teeth of the first teeth part 31A. This ensures smooth movement of the second teeth part 31.

Since the first teeth part 31A and the second teeth part 31B have the same shape, the second teeth part 31B will be representatively described below.

The sine wave in the sine-waved portion 33 of the second teeth part 31B is expressed in the following mathematical formula (1), where the origin represents the inflection point of the sine wave, the x-axis represents the circumferential direction of the gear (second gear 3B), and the y-axis represents the direction of the central axis O1, as shown in FIG. 3.

$$y = \frac{A}{2} sin \frac{Z}{r} x \qquad [ Formula 1 ]$$

In the formula (1), the sign A denotes the whole depth of each tooth of the second teeth part 31B. The sign Z denotes the total number of the teeth of the second teeth part 31B, that is, the number of teeth. The sign r denotes a distance from the central axis O1 to a given point on the second teeth part 31B (see FIG. 7). Note that (d/2)<r<(D/2) is satisfied (the sign d denotes the inner diameter of the second teeth part 31B, and the sign D denotes the outer diameter of the second teeth part 31B).

Further, as shown in FIG. 3, the wavelength λ is (2πr)/Z, and the amplitude is A/2.

As shown in FIG. 6, the tooth thickness t3 of each tooth of the second teeth part 31B decreases toward the central axis O1. The “tooth thickness” refers to the thickness of the tooth (each tooth of the second teeth part 31B) measured on the pitch circle of the gear (second gear 3B). Since the tooth thickness t3 decreases, an extension line EL311 of a ridge 311 of each tooth of the second teeth part 31B intersects the central axis O1. Further, an extension line EL312 of a bottom line 312 of each tooth of the second teeth part 31B also intersects the central axis O1. Since the second teeth part 31B is formed like this, the wear-prevention effect is exhibited more reliably, and thus fluctuations in the operating torque can be prevented or reduced more reliably.

As shown in FIG. 7, the whole depth H3 of the teeth of the second teeth part 31B is constant along the direction toward the central axis O1. The “whole depth” is the overall height of the tooth (each tooth of the second teeth part 31B), and is the sum of the addendum and the dedendum of the tooth. Due to the constant whole depth H3 combined with, for example, a decrease in the tooth thickness t3, fluctuations in the operating torque can be prevented or reduced more reliably.

As shown in FIG. 3, the first gear 3A has first recesses 34A each of which is located between adjacent teeth of the first teeth part 31A and is recessed toward the other side in the direction along the central axis O1. In the same manner, the second gear 3B has second recesses 34B each of which is located between adjacent teeth of the second teeth part 31B and is recessed toward one side in the direction along the central axis O1. When the first gear 3A and the second gear 3B mesh with each other, the ridge 311 of each tooth of the first teeth part 31A is not in contact with the second teeth part 31B, and the ridge 311 of each tooth of the second teeth part 31B is not in contact with the first teeth part 31A. This configuration provides a backlash between the first teeth part 3A and the second teeth part 3B, and thus the first teeth part 3A and the second teeth part 3B can be smoothly engaged with each other. In other words, unevenness of engagement (generation of play) between the first teeth part 3A and the second teeth part 3B is reduced. Further, when the engagement of the first gear 3A and the second gear 3B is released after the torque limiter 1 is operated, an impact force may be applied to the first gear 3A by the elastic force of the elastic members 4. However, this configuration prevents transmission of such an impact force to the tooth tips of each gear. The first recess 34A and the second recess 34B may have a constant width in the radial direction, or may have a width that gradually decreases in the radially inward direction, i.e., toward the central axis O1.

Next, other application examples of the geared motor 100 will be described with reference to FIGS. 8 and 9.

FIG. 8 shows a smartphone 500 including a drive mechanism 200 that allows a camera thereof to move up and down freely. The drive mechanism 200 is a camera mechanism driven by the geared motor 100. As described above, fluctuations of the operating torque can be prevented or reduced, and thus the camera can be steadily moved up and down.

As shown in FIG. 9, a robot 400 includes the geared motor 100 and an arm 300 driven by the geared motor 100. The geared motor 100 is incorporated in the joint of the arm 300. As described above, fluctuations of the operating torque can be prevented or reduced, and thus the arm 300 can move steadily.

Although the torque limiter, the geared motor, the drive mechanism, and the robot of the present disclosure have been described with reference to the embodiments shown in the figures, the present disclosure is not limited thereto. The components that form the torque limiter, the geared motor, the drive mechanism, and the robot may be replaced with those having a configuration capable of performing the same function. Moreover, any given components may be added.

What is claimed is:

1. A torque limiter comprising:
a shaft extending along a central axis;
a first gear that has a disk shape centered on the central axis, includes a first teeth part with a plurality of teeth on one surface thereof on one side of the torque limiter in a direction along the central axis, and is rotatable about the central axis together with the shaft;
a second gear that has a disk shape centered on the central axis, and includes a second teeth part with a plurality of teeth on one surface thereof on another side of the torque limiter in the direction along the central axis, the second teeth part being configured to mesh with the first teeth part; and
an elastic member configured to press one of the first gear and the second gear against another one of the first gear and the second gear,
wherein the first teeth part and the second teeth part respectively have sine-waved portions in which teeth surfaces of the first teeth part and the second teeth part have a shape of a sine wave when viewed in a direction orthogonal to the central axis, the teeth surfaces of the first teeth part and the second teeth part being configured to contact each other.

2. The torque limiter according to claim 1,
wherein the first teeth part and the second teeth part each have a tooth thickness decreasing toward the central axis.

3. The torque limiter according to claim 1,
wherein each tooth of the first teeth part and the second teeth part has a whole depth that is constant along a direction toward the central axis.

4. The torque limiter according to claim 1,
wherein the first gear has first recesses each of which is located between adjacent teeth of the first teeth part and is recessed toward the other side of the torque limiter in the direction along the central axis, and
wherein the second gear has second recesses each of which is located between adjacent teeth of the second teeth part and is recessed toward the one side of the torque limiter in the direction along the central axis.

5. The torque limiter according to claim 1,
wherein the shaft includes a flange part having an opposing surface facing in the direction along the central axis, and
wherein the elastic member is disposed between the opposing surface and the first gear.

6. The torque limiter according to claim 1,
wherein the elastic member is formed of a disc spring.

7. The torque limiter according to claim 5,
wherein the second gear is disposed opposite the elastic member across the first gear.

8. The torque limiter according to claim 1, further comprising a transmission gear configured to transmit power from a drive source to the second gear.

9. The torque limiter according to claim 1,
wherein the shaft has on an outer periphery thereof at least a pair of flat surfaces facing in opposite directions,
wherein the first gear has a through hole into which the shaft is inserted; and
wherein the through hole includes contact surfaces configured to contact the flat surfaces, respectively.

10. The torque limiter according to claim 9,
wherein an inner periphery of the through hole includes:
connecting surfaces each of which connects the contact surfaces, and
concave surfaces each of which is disposed at a boundary between one of the contact surfaces and one of the connecting surfaces, and is recessed in a direction away from the central axis.

11. A geared motor comprising:
the torque limiter according to claim 1; and
a motor configured to transmit torque to the torque limiter.

12. A drive mechanism that is driven by the geared motor according to claim 11.

13. A robot comprising:
the geared motor according to claim 11; and
an arm that is driven by the geared motor.
